(19) United States
(12) Patent Application Publication
(10) Pub. No.: US 2025/0335162 A1
(43) Pub. Date: Oct. 30, 2025

(54) CREATING AN APPLICATION

(71) Applicant: Beijing Zitiao Network Technology Co., Ltd., Beijing (CN)

(72) Inventor: Yuyang PAN, Beijing (CN)

(21) Appl. No.: 18/820,961

(22) Filed: Aug. 30, 2024

(30) Foreign Application Priority Data
Apr. 30, 2024 (CN) 202410543742.2`

(51) Int. Cl. G06F 8/35

(52) U.S. Cl. CPC G06F 8/35

(57) ABSTRACT

Embodiments of the disclosure relate to a method, an apparatus, a device and storage medium for creating an application. One of the embodiments includes: obtaining configuration information, wherein the configuration information indicates a plurality of processing entities for creating an application, the configuration information further comprises jump information associated with a target processing entity in the plurality of processing entities, the jump information comprises at least one jump control parameter, the at least one jump control parameter is associated with a jump decision process at the target processing entity, and the jump decision process is performed by a jump control entity independent of the target processing entity; and creating a target application based on the configuration information. In this way, embodiments of the present disclosure may support a user in configuring a jump decision process of processing entities (for example, agents or sub-bots), thereby improving flexibility of application development.

### CROSS REFERENCE

The present application claims priority to Chinese Patent Application No. 202410543742.2, filed on Apr. 30, 2024, and entitled “METHOD, APPARATUS, DEVICE, AND STORAGE MEDIUM FOR CREATING AN APPLICATION”, the entirety of which is incorporated herein by reference.

### FIELD

Example embodiments of the present disclosure generally relate to the field of computers, and in particular, to creating an application.

### BACKGROUND

With the development of computer technologies, people can create and publish various types of applications through some platforms. For example, with the development of machine learning techniques, one may quickly create applications by configuring parameters of the applications, such as models used by applications, available plug-ins, and the like.

### SUMMARY

In a first aspect of the present disclosure, a method of creating an application is provided. The method includes: obtaining configuration information, wherein the configuration information indicates a plurality of processing entities for creating an application, the configuration information further comprising jump information associated with a target processing entity in the plurality of processing entities, the jump information comprising at least one jump control parameter, wherein the at least one jump control parameter is associated with a jump decision process at the target processing entity, and the jump decision process is performed by a jump control entity independent of the target processing entity; and creating a target application based on the configuration information.

In a second aspect of the present disclosure, a method for request processing is provided. The method includes: receiving, by a target application, a target request to be processed; in response to determining that the target request is to be processed by a first processing entity of the target application, providing, using the first processing entity, a first output content for the target request; and in response to determining that the target request is processed by jumping from the first processing entity to a second processing entity to process, providing, using the second processing entity, a second output content for the target request.

In a third aspect of the present disclosure, an apparatus for creating an application is provided. The apparatus includes: an obtaining module configured to obtain configuration information, wherein the configuration information indicates a plurality of processing entities for creating an application, the configuration information further comprising jump information associated with a target processing entity in the plurality of processing entities, the jump information comprising at least one jump control parameter, wherein the at least one jump control parameter is associated with a jump decision process at the target processing entity, and the jump decision process is performed by a jump control entity independent of the target processing entity; and a creating module configured to create a target application based on the configuration information.

In a fourth aspect of the present disclosure, an apparatus for request processing is provided. The apparatus includes: a receiving module configured to receive, by a target application, a target request to be processed; a first output module configured to, in response to determining that the target request is to be processed by a first processing entity of the target application, provide, using the first processing entity, a first output content for the target request; and a second output module configured to, in response to determining that the target request is processed by jumping from the first processing entity to a second processing entity to process, provide, using the second processing entity, a second output content for the target request.

In a fifth aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect or the second aspect.

In a sixth aspect of the present disclosure, a computer-readable storage medium is provided. The computer-readable storage medium stores a computer program, and the computer program is executable by the processor to perform operations that implement the method of the first aspect or the second aspect.

It should be understood that the content described in this summary section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment.

FIG. 2 illustrates a flowchart of an example process of creating an application.

FIG. 3 illustrates an example interface.

FIG. 4 illustrates a flowchart of an example request processing process.

FIG. 5 illustrates a schematic structural block diagram of an example apparatus for creating an application.

FIG. 6 illustrates a schematic structural block diagram of an example apparatus for request processing.

FIG. 7 illustrates a block diagram of an example electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “include” and the like should be understood to include “include but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or same objects. Other explicit and implicit definitions may also be included below.

Embodiments of the present disclosure may relate to data of a user, acquisition and/or use of the data, etc. These aspects follow the corresponding laws and regulations and related regulations. In the embodiments of the present disclosure, the collecting, obtaining, conducting, processing, forwarding, use and the like of all data are performed on the premise that the user knows and confirms. Accordingly, when implementing the embodiments of the present disclosure, the user should be notified of the types of the data or information that may be involved, the usage scope, the usage scenario, and the like and the authorization of the user should be obtained in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, the processing may be performed on the premise of having a legal basis (for example, obtaining consent of the subject of personal information, or it is necessary for fulfilling a contract), and processing is only within a specified or agreed range. If a user rejects processing personal information other than necessary information required by the basic function, the user using basic functions will not be affected.

Conventionally, users support configuring models, plug-ins, and the like used by applications to quickly create applications, such as a robot program (bot). However, some applications may include multiple processing entities (e.g., sub-bots or agents). Therefore, how to configure the jump between such processing entities becomes the focus of concern by people.

Embodiments of the present disclosure provide a solution for creating an application. According to the solution, configuration information may be obtained, where the configuration information indicates a plurality of processing entities for creating an application, the configuration information further includes jump information associated with a target processing entity in the plurality of processing entities, the jump information includes at least one jump control parameter, the at least one jump control parameter is associated with a jump decision process at the target processing entity, and the jump decision process is performed by a jump control entity independent of the target processing entity. Further, the target application may be created based on the configuration information.

In this way, embodiments of the present disclosure may support a user configuration of a jump decision process of processing entities (for example, agents or sub-bots), thereby improving flexibility of application development.

Various example implementations of this solution are described in detail below in conjunction with the accompanying drawings.

### Example Environment

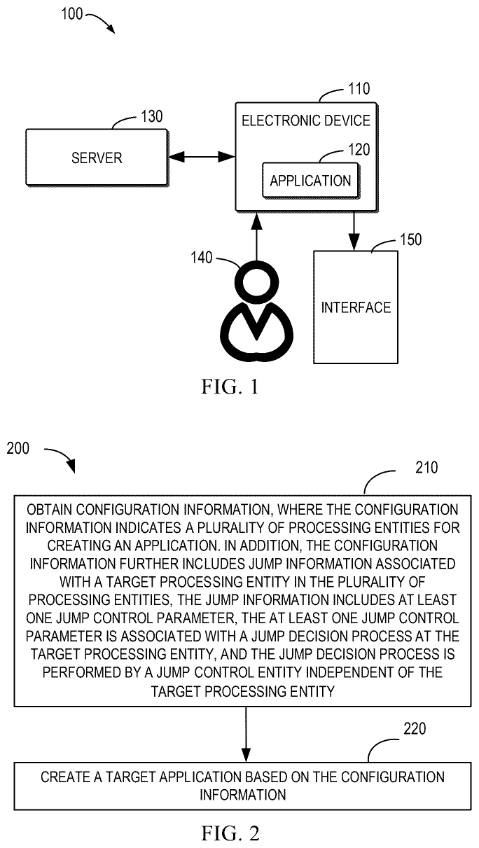

FIG. 1 illustrates a schematic diagram of an example environment 100 in which embodiments of the present disclosure can be implemented. As shown in FIG. 1, the example environment 100 may include an electronic device 110.

In the example environment 100, the electronic device 110 may run an application 120 that supports interface interaction. The application 120 may be any suitable type of application for interface interaction, examples of which may include, but are not limited to, development applications or other suitable applications that support application development. A user 140 may interact with the application 120 via the electronic device 110 and/or its attachment devices.

In the environment 100 of FIG. 1, if the application 120 is in an active state, the electronic device 110 may present, via the application 120, an interface 150 for supporting creation of an application.

In some embodiments, the electronic device 110 communicates with a server 130 to enable provisioning of services to the application 120. The electronic device 110 may be any suitable type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In embodiments of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Process of Creating An Application

FIG. 2 illustrates a flowchart of a process 200 for creating an application according to some embodiments of the present disclosure. Process 200 may be implemented at the electronic device 110. The process 200 is described below with reference to FIG. 1.

At block 210, the electronic device 110 obtains configuration information. The configuration information indicates a plurality of processing entities for creating an application. In addition, the configuration information further includes jump information associated with a target processing entity in the plurality of processing entities. The jump information includes at least one jump control parameter, where the at least one jump control parameter is associated with a jump decision process at the target processing entity. The jump decision process is performed by a jump control entity independent of the target processing entity.

In some embodiments, the jump control entity, which is independent of the target processing entity, may include any suitable processing entity implemented by using a different model than the target processing entity. Alternatively, or in addition, the jump control entity, independent of the target processing entity, may also be implemented by using the same underlying model as the target processing entity. However, the jump control entity and the target processing entity may have independent configuration information. For example, the target processing entity and the jump control entity may be implemented based on the same language model, but have different configuration information s prompt, knowledge information, plug-in information, and the like.

In some embodiments, the electronic device 110 may support a user creation of a multi-processing entity-based application. Such processing entities may include, for example, existing applications or agents. In some embodiments, the electronic device 110 may, for example, support a user creation of multiple nodes to configure multiple processing entities in an application.

As an example, the electronic device 110 may receive various settings about respective nodes from a user, for example, a model identifier corresponding to a node, model parameters, plug-in information of a node, knowledge information of a node, and the like.

Considering that each processing entity has different processing capabilities, in order to improve the quality of request processing, in embodiments of the present disclosure, a user may also configure a jump between processing entities to improve the efficiency of request processing.

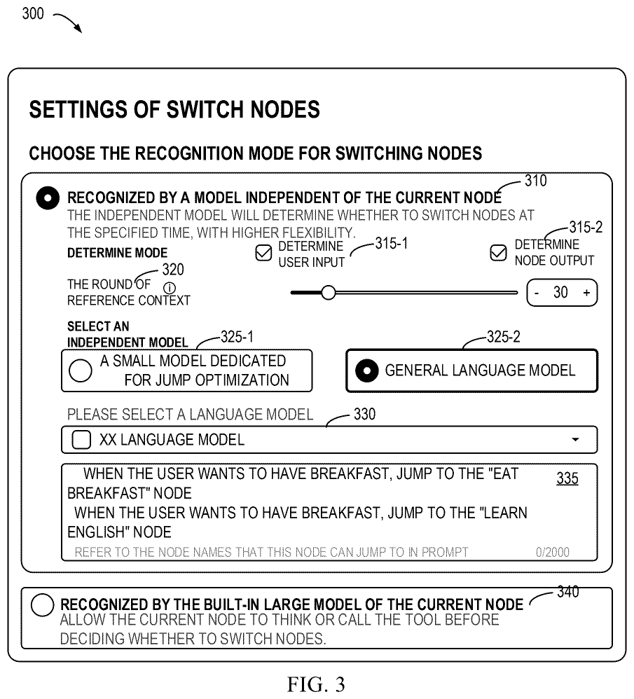

FIG. 3 illustrates an example interface 300 according to some embodiments of the present disclosure. The interface 300 may be, for example, a configuration interface for a target processing entity (corresponding to a target node) in a plurality of processing entities.

As shown in FIG. 3, the electronic device 110 may, for example, support the user in configuring two jump modes, that is, a first jump mode corresponding to a configuration item 310 and a second jump mode corresponding to a configuration item 320.

Specifically, the first jump mode may indicate that the jump decision process is performed by utilizing a jump control entity different from the current target processing entity. For example, the jump control entity may be a model independent of the target processing entity. In contrast, the second jump mode may indicate that the jump decision process is performed by the target processing entity itself.

As shown in FIG. 3, if the configuration item 310 is selected, the electronic device 110 may obtain the jump information associated with the target processing entity by using the interface 300, such that the jump information may include at least one jump control parameter associated with the jump decision process of the target processing entity.

Specifically, as shown in FIG. 3, the interface 300 may include a configuration item 325-1 and a configuration item 325-2 for configuring the first parameter. In some embodiments, the first parameter may indicate the jump control entity for performing the jump decision process.

As shown in FIG. 3, the configuration item 325-1 may, for example, indicate that the jump control entity is a dedicated model trained for the jump decision task, and the configuration item 325-2 may indicate that the jump control entity is a general language model.

As an example, the dedicated model may have a faster processing speed, and/or a lower processing cost than the general language model. In contrast, the general language model may, for example, cover a more comprehensive scenario, and reduce the failure of the jump decision.

As shown in FIG. 3, if the configuration item 325-2 is selected, the electronic device 110 may support the user in selecting a specific language model through a control 330. Additionally, in the case of using a general language model, the electronic device 110 may, for example, also provide an input control 335 to support the user in inputting the prompt text.

In some embodiments, the electronic device 110 may obtain the prompt text through the input control 335. As an example, the prompt text may include one or more jump policies entered by the user. Such prompt text may be provided to the specified language model to perform a jump decision process.

Specifically, when performing the jump decision process by utilizing the general language model, target prompt information may be constructed and provided to the general language model. In some embodiments, such target prompt information may include description information of a set of associated processing entities to which the target processing entity is capable of jumping. For example, such description information may include entity identifiers of the set of associated processing entities, scenarios applicable to the entities, and the like.

Additionally or alternatively, such target prompt information may also include context information associated with the target processing entity. For example, the context information may include a predetermined round of context dialog.

Additionally, or alternatively, such target prompt information may include a prompt text input by a user, for example, a prompt text entered via the input control 335.

Additionally, or alternatively, such target prompt information may further include a target request to be processed. For example, such a target request may indicate a query term entered by the user to the created target application.

Therefore, the general language model may perform a decision on whether to jump from a target processing entity and/or jump to a particular processing entity based on the target prompt information.

For a dedicated model, the input information of the dedicated model may be constructed based on description information, context information, target requests to be processed and the like of a set of associated processing entities as discussed above. Further, the dedicated model may perform a decision on whether to jump from the target processing entity and/or jump to a particular processing entity based on the input information. In some scenarios, in the case of using a dedicated model, the electronic device 110 may, for example, not support a user entering the prompt text by, for example, an input control.

Referring to FIG. 3, the electronic device 110 may further provide a configuration item 315-1 and a configuration item 315-2 for configuring a second parameter. Specifically, the second parameter may indicate that the jump control entity performs the jump decision process based on input information and/or output information of the target processing entity.

In some embodiments, the configuration item 315-1 may indicate that the jump decision process is performed based on the input information. Specifically, if the configuration item 315-1 is selected, the jump control entity is configured to: before the target processing entity processes a first request, determine whether to jump to a further processing entity to process the first request based on the first request and first context information.

For example, if the jump control entity determines that the target processing entity is not suitable for processing the first request, the target processing entity will no longer process the first request and may jump to a determined further processing entity to process the first request.

In some embodiments, configuration item 315-2 may indicate that the jump decision process is performed based on the output information. Specifically, if the configuration item 315-1 is selected, the jump control entity is configured to: after the target processing entity processes a second request, determine whether to jump to a further processing entity to process the second request based on the second request, second context information and output content for the second request of the target processing entity.

For example, the jump control entity may determine, based on the output content, that the second request still needs to continue to be processed by additional processing entities. Correspondingly, in the case of the target processing entity providing the output content, the target processing entity may still jump to a further processing entity to continue processing the second processing request according to the output content.

In some embodiments, the configuration item 315-1 and the configuration item 315-2, for example, may be enabled simultaneously. For example, the target processing entity may enable performing node jumps based on output content, and a further processing entity is also configured to perform node adjustments based on input content. Correspondingly, when determining to jump to the further processing entity based on the output content of the target processing entity, the jump control entity may perform a jump decision process corresponding to the further processing entity before the further processing entity processes the request, to determine whether to continue processing the request using another processing entity.

Referring to FIG. 3, the electronic device 110 may further include a control 320 used to configure a third parameter. In some embodiments, the third parameter indicates a range of context information provided to the jump control entity to perform the jump decision process. For example, the control 320 may be configured to provide the round of the context dialog of the jump control entity.

In some embodiments, when it is determined that the target processing entity needs to jump to a further processing entity to process the target request, context information associated with the target processing entity is provided to another processing entity for processing the target request.

At block 220, the electronic device 110 creates a target application based on the configuration information.

As an example, the electronic device 110 may create a corresponding target application, for example, a bot, based on the configuration information. Further, the bot may be published or shared to other users, for example.

In some embodiments, in the case of obtaining a permission of a publisher, for example, other users may also be supported to create a template of the published application, and a new application may be created by editing the corresponding node connection graph, thereby improving the efficiency of the application.

Based on the foregoing process, embodiments of the present disclosure may support fine control of a jump decision process performed by a user for a target processing entity, thereby improving flexibility of application development.

### Example Request Processing Process

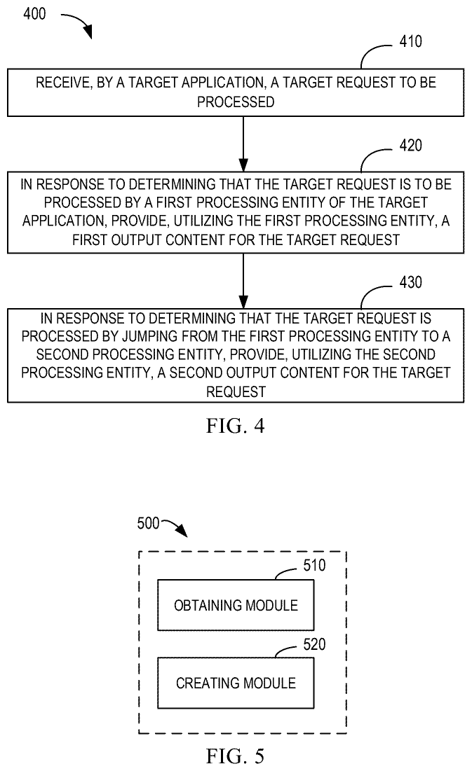

FIG. 4 illustrates a flowchart of an example request processing process 400 according to some embodiments of the present disclosure. The process 400 may be implemented at an electronic device 110 in which a target application is deployed. It should be understood that the electronic device performing the process 400 may be the same as or different from the electronic device performing the process 200. The process 400 is described below with reference to FIG. 1.

As shown in FIG. 4, at block 410, a target request to be processed is received by a target application. As an example, such a target request may include, for example, a query term entered by a user. In some embodiments, the target application may be created based on the process 200 described above with reference to FIG. 2.

As an example, the target application may receive the target request based on conversational interactions, interface calls, or other suitable means.

At block 420, in response to determining that the target request is to be processed by a first processing entity of the target application, the target application provides, utilizing the first processing entity, a first output content for the target request.

As discussed above, the user may configure the jump decision process based on the input information and/or the output information for the first processing entity configuration. When the first processing entity is configured to perform the jump decision process based on the output information, the target application may first utilize the first processing entity to output the first output content for the target request. For example, the target application may utilize a conversational interaction window to provide the first output content of the first processing entity to the user.

At block 430, in response to determining that the target request is processed by jumping from the first processing entity to a second processing entity, the target application provides, utilizing the second processing entity, a second output content for the target request.

Further, as discussed above, the target application may determine to jump from the first processing entity to the second processing entity to continue processing the target request based on the configuration information. In some embodiments, the configuration information includes jump information associated with the first processing entity. The jump information includes at least one jump control parameter. The at least one jump control parameter is associated with a jump decision process at the first processing entity, and the jump decision process is performed by a jump control entity independent of the first processing entity.

Specifically, the user may, for example, configure the jump control parameter by the configuration item 315-2 described above, so that the target application may continue to process the node processed jump decision process based on the first output content after the first processing entity provides the first output content, and determine that the target request needs to be jumped to the second processing entity to continue processing the target request.

Further, as discussed above, in a case where the second processing entity is configured with performing the jump decision process based on the input information, the target application may perform the jump decision process before node processing based on input information (such as a target request, context information, and the like) of the second processing entity. Correspondingly, when it is determined that the target request continues to be processed by the second processing entity, the target application may generate the second output content by utilizing the second processing entity. For example, the target application may utilize a conversational interaction window to provide the first output content of the first processing entity to the user.

In this way, embodiments of the present disclosure may provide multiple output content from multiple different processing entities for a single request by a user. Therefore, embodiments of the present disclosure may provide request response content in combination with output results of the multiple different processing entities, so that the quality of the response content is improved.

### Example Apparatus and devices

Embodiments of the present disclosure further provide a corresponding apparatus for implementing the above method or process. FIG. 5 illustrates a schematic structural block diagram of an example apparatus 500 for creating an application according to some embodiments of the present disclosure. The apparatus 500 may be implemented or included in the electronic device 110. The various modules/components in the apparatus 500 may be implemented by hardware, software, firmware, or any combination thereof.

As shown in FIG. 5, the apparatus 500 includes an obtaining module 510 configured to obtain configuration information, wherein the configuration information indicates a plurality of processing entities for creating an application. The configuration information further comprises jump information associated with a target processing entity in the plurality of processing entities, the jump information comprises at least one jump control parameter, the at least one jump control parameter is associated with a jump decision process at the target processing entity. The jump decision process is performed by a jump control entity independent of the target processing entity. The apparatus 500 further includes a creating module 520 configured to create a target application based on the configuration information.

In some embodiments, the at least one jump control parameter comprises a first parameter indicating the jump control entity for performing the jump decision process.

In some embodiments, the jump control entity is: a dedicated model trained for a jump decision task; or a general language model.

In some embodiments, the obtaining module 510 is further configured to: in response to the first parameter indicating that the jump control entity is the general language model, obtain an input prompt text, the prompt text being provided to the jump control entity for performing the jump decision process.

In some embodiments, the general language model is configured to perform the jump decision process based on target prompt information, wherein the target prompt information comprises at least one of: description information of a set of associated processing entities to which the target processing entity is capable of jumping; context information associated with the target processing entity; a prompt text input by the user; or a target request to be processed.

In some embodiments, the at least one jump control parameter includes a second parameter indicating that the jump control entity performs the jump decision process based on input information and/or output information of the target processing entity.

In some embodiments, in response to the second parameter indicating performing the jump decision process based on the input information, the jump control entity is configured to: before the target processing entity processes a first request, determine whether to jump to a further processing entity to process the first request based on the first request and first context information.

In some embodiments, in response to the second parameter indicating performing the jump decision process based on the output information, the jump control entity is configured to: after the target processing entity processes a second request, determine whether to jump to a further processing entity to process the second request based on the second request, second context information and output content for the second request of the target processing entity.

In some embodiments, the at least one jump control parameter comprises a third parameter indicating a range of context information provided to the jump control entity to perform the jump decision process.

In some embodiments, during processing a target request by the target application, in response to the target application jumping from the target processing entity to a further processing entity to process the target request, context information associated with a target processing entity is provided to the further processing entity for processing the target request.

FIG. 6 illustrates a schematic structural block diagram of an example apparatus 600 for request processing according to some embodiments of the present disclosure. The apparatus 600 may be implemented or included in the electronic device 110. The various modules/components in the apparatus 600 may be implemented by hardware, software, firmware, or any combination thereof.

As shown in FIG. 6, the apparatus 600 includes: a receiving module 610 configured to receive, by a target application, a target request to be processed; a first output module 620 configured to, in response to determining that the target request is to be processed by a first processing entity of the target application, provide, utilizing the first processing entity, a first output content for the target request; and a second output module 630 configured to, in response to determining that the target request is processed by jumping from the first processing entity to a second processing entity to process, provide, utilizing the second processing entity, a second output content for the target request.

In some embodiments, the apparatus 600 includes a jump module configured to: determine, based on configuration information of the target application, that the target request is processed by jumping from the first processing entity to the second processing entity, wherein the configuration information comprises jump information associated with the first processing entity, the jump information comprises at least one jump control parameter, the at least one jump control parameter is associated with a jump decision process at the first processing entity, and the jump decision process is performed by a jump control entity independent of the first processing entity.

In some embodiments, the at least one jump control parameter indicates that the jump control entity performs the jump decision process at least based on a first input content of the first processing entity.

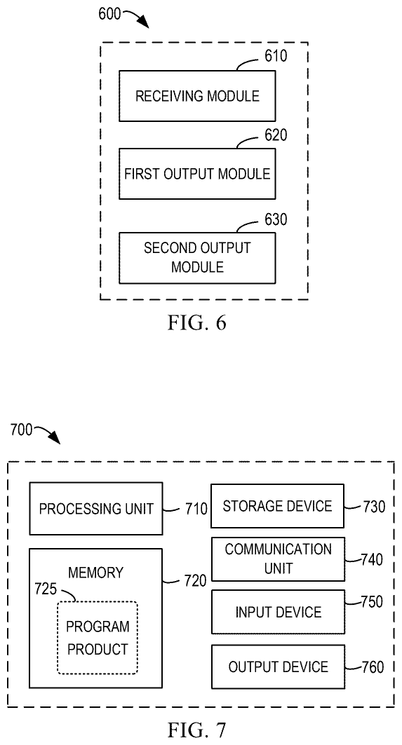

FIG. 7 illustrates a block diagram of an electronic device 700 in which one or more embodiments of the present disclosure may be implemented. It should be understood that the electronic device 700 illustrated in FIG. 7 is merely an example and should not constitute any limitation on the functionality and scope of the embodiments described herein. The electronic device 700 shown in FIG. 7 may be configured to implement the electronic device 110 in FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In a multiprocessor system, multiple processing units execute computer-executable instructions in parallel to improve parallel processing capabilities of electronic device 700.

The electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, magnetic disk, or any other medium, which may be capable of storing information and/or data and may be accessed within electronic device 700.

The electronic device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 is configured to communicate with another electronic device through a communication medium. Additionally, the functionality of components of the electronic device 700 may be implemented in a single computing cluster or multiple computing machines capable of communicating over a communication connection. Therefore, the electronic device 700 may operate in a networked environment using logical connections with one or more other servers, network personal computers (PCs), or another network Node.

The input device 750 may be one or more input devices, such as a mouse, a keyboard, a trackball, and the like. The output device 760 may be one or more output devices, such as a display, a speaker, a printer, or the like. The electronic device 700 may also communicate with one or more external devices (not shown) through the communication unit 740 as needed, external devices such as storage devices, display devices, etc., communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Various aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general-purpose computer, special-purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the drawings show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the drawings. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method of creating an application, comprising:
obtaining configuration information, wherein the configuration information indicates a plurality of processing entities for creating an application, the configuration information further comprising jump information associated with a target processing entity in the plurality of processing entities, the jump information comprising at least one jump control parameter, wherein the at least one jump control parameter is associated with a jump decision process at the target processing entity, and the jump decision process is performed by a jump control entity independent of the target processing entity; and
creating a target application based on the configuration information.

2. The method of claim 1, wherein the at least one jump control parameter comprises a first parameter indicating the jump control entity for performing the jump decision process.

3. The method of claim 2, wherein the jump control entity is:
a dedicated model trained for a jump decision task; or
a general language model.

4. The method of claim 3, further comprising:
in response to the first parameter indicating that the jump control entity is the general language model, obtaining an input of a prompt text, wherein the prompt text is provided to the jump control entity for performing the jump decision process.

5. The method of claim 3, wherein the general language model is configured to perform the jump decision process based on target prompt information, wherein the target prompt information comprises at least one of:
description information of a set of associated processing entities to which the target processing entity is capable of jumping;
context information associated with the target processing entity;
a prompt text input by a user; or
a target request to be processed.

6. The method of claim 1, wherein the at least one jump control parameter comprises a second parameter indicating that the jump control entity performs the jump decision process based on input information and/or output information of the target processing entity.

7. The method of claim 6, wherein in response to the second parameter indicating performing the jump decision process based on the input information, the jump control entity is configured to: before the target processing entity processes a first request, determine whether to jump to a further processing entity to process the first request based on the first request and first context information.

8. The method of claim 6, wherein in response to the second parameter indicating performing the jump decision process based on the output information, the jump control entity is configured to: after the target processing entity processes a second request, determine whether to jump to a further processing entity to process the second request based on the second request, second context information and output content for the second request of the target processing entity.

9. The method of claim 1, wherein the at least one jump control parameter comprises a third parameter, the third parameter indicating a range of context information provided to the jump control entity to perform the jump decision process.

10. The method of claim 1, wherein:
during a processing of a target request by the target application, in response to the target application jumping from the target processing entity to a further processing entity to process the target request, context information associated with a target processing entity is provided to the further processing entity for processing the target request.

11. A method for request processing, comprising:
receiving, by a target application, a target request to be processed;
in response to determining that the target request is to be processed by a first processing entity of the target application, providing, using the first processing entity, a first output content for the target request; and
in response to determining that the target request is processed by jumping from the first processing entity to a second processing entity, providing, using the second processing entity, a second output content for the target request.

12. The method of claim 11, further comprising:
determining, based on configuration information of the target application, that processing the target request comprises jumping from the first processing entity to the second processing entity, wherein the configuration information comprises jump information associated with the first processing entity, the jump information comprises at least one jump control parameter, the at least one jump control parameter is associated with a jump decision process at the first processing entity, and the jump decision process is performed by a jump control entity independent of the first processing entity.

13. The method of claim 12, wherein the at least one jump control parameter indicates that the jump control entity performs the jump decision process at least based on a first input content of the first processing entity.

14. An electronic device, comprising:
at least one processing unit; and
at least one memory coupled to the at least one processing unit and storing instructions for execution by the at least one processing unit, the instructions, when executed by the at least one processing unit, causing the electronic device to perform operations comprising:
obtaining configuration information, wherein the configuration information indicates a plurality of processing entities for creating an application, the configuration information further comprising jump information associated with a target processing entity in the plurality of processing entities, the jump information comprising at least one jump control parameter, wherein the at least one jump control parameter is associated with a jump decision process at the target processing entity, and the jump decision process is performed by a jump control entity independent of the target processing entity; and
creating a target application based on the configuration information.

15. The electronic device of claim 14, wherein the at least one jump control parameter comprises a first parameter indicating the jump control entity for performing the jump decision process.

16. The electronic device of claim 15, wherein the jump control entity is:
a dedicated model trained for a jump decision task; or a general language model.

17. The electronic device of claim 16, the operations further comprising:
in response to the first parameter indicating that the jump control entity is the general language model, obtaining an input prompt text, the prompt text being provided to the jump control entity for performing the jump decision process.

18. The electronic device of claim 16, wherein the general language model is configured to perform the jump decision process based on target prompt information, wherein the target prompt information comprises at least one of:
description information of a set of associated processing entities to which the target processing entity is capable of jumping;
context information associated with the target processing entity;
a prompt text input by a user; or
a target request to be processed.

19. The electronic device of claim 14, wherein the at least one jump control parameter comprises a second parameter indicating that the jump control entity performs the jump decision process based on input information and/or output information of the target processing entity.

20. The electronic device of claim 19, wherein in response to the second parameter indicating performing the jump decision process based on the input information, the jump control entity is configured to: before the target processing entity processes a first request, determine whether to jump to a further processing entity to process the first request based on the first request and first context information.
